(19) United States
(12) Patent Application Publication
(10) Pub. No.: US 2015/0319514 A1
(43) Pub. Date: Nov. 5, 2015

(54) ELECTROACTIVE POLYMER ACTUATED APERTURE

(71) Applicants: Roger N. HITCHCOCK, San Leadro, CA (US); Arthur Hughes MUIR, San Mateo, CA (US); Eric A. NIETERS, Mountain View, CA (US); Alireza ZARRABI, Sunnyvale, CA (US); BAYER MATERIALSCIENCE AG, Leverkusen (DE)

(72) Inventors: Roger N. Hitchcock, San Leandro, CA (US); Arthur H. Muir, San Mateo, CA (US); Eric A. Nieters, San Francisco, CA (US); Alireza Zarrabi, Los Gatos, CA (US)

(21) Appl. No.: 14/649,743

(22) PCT Filed: Dec. 6, 2013
(86) PCT No.: PCT/US2013/073478

§ 371 Date: Jun. 4, 2015

Related U.S. Application Data
(60) Provisional application No. 61/734,627, filed on Dec. 7, 2012.

(51) Int. Cl. H04R 1/00; H04R 17/00; H04R 31/00; H04R 7/02

(52) U.S. Cl. CPC H04R 1/00; H04R 7/02; H04R 17/005; H04R 31/003

(57) ABSTRACT

An apparatus (200) is disclosed. The apparatus includes a rigid frame (206), an electroactive polymer film (204) defining an aperture (202) where the electroactive polymer film has a first and second side. A first electrode is located on the first side of the electroactive polymer film and a second electrode is located on the second side of the electroactive polymer film. The aperture is configured to deform upon the application of an electric voltage potential to the first and second electrodes. A method of making an electroactive device is also disclosed. The method includes positioning an electroactive polymer film within a rigid frame and forming an aperture within the electroactive polymer film.

### RELATED APPLICATIONS

This application claims the benefit, under 35 USC §119(e), of U.S. Provisional Application No. 61/734,627 filed Dec. 7, 2012 entitled “EAP APERTURE” the entirety of which is incorporated herein by reference.

### FIELD OF THE INVENTION

The present invention is directed in general to electroactive polymer devices comprising a deformable aperture and manufacturing processes for producing same. More particularly, the present invention is directed to electroactive polymer devices comprising an aperture that changes in size upon the application of an electric voltage potential to electrodes coupled to the electroactive polymer film and manufacturing processes for producing same.

### BACKGROUND OF THE INVENTION

A tremendous variety of devices used today rely on actuators of one sort or another to convert electrical energy to mechanical energy. Conversely, many power generation applications operate by converting mechanical action into electrical energy. Employed to harvest mechanical energy in this fashion, the same type of device may be referred to as a generator. Likewise, when the structure is employed to convert physical stimulus such as vibration or pressure into an electrical signal for measurement purposes, it may be characterized as a sensor. Yet, the term “transducer” may be used to generically refer to any electroactive devices described herein.

A number of design considerations favor the selection and use of advanced dielectric elastomer materials, also referred to as “electroactive polymers”, for the fabrication of transducers. These considerations include potential force, power density, power conversion/consumption, size, weight, cost, response time, duty cycle, service requirements, environmental impact, etc. As such, in many applications, electroactive polymer technology offers an ideal replacement for piezoelectric, shape-memory alloy and electromagnetic devices such as motors and solenoids.

An electroactive polymer transducer comprises two electrodes having deformable characteristics and separated by a thin elastomeric dielectric material. When a voltage difference is applied to the electrodes, the oppositely charged electrodes attract each other thereby compressing the polymer dielectric layer therebetween. As the electrodes are pulled closer together, the dielectric polymer film becomes thinner (the Z-axis component contracts) as it expands in the planar directions (along the X- and Y-axes), i.e., the displacement of the film is in-plane. The electroactive polymer film may also be configured to produce movement in a direction orthogonal to the film structure (along the Z-axis), i.e., the displacement of the film is out-of-plane. U.S. Pat. No. 7,567,681 discloses electroactive polymer film constructs which provide such out-of-plane displacement—also referred to as surface deformation or as thickness mode deflection.

The material and physical properties of the electroactive polymer film may be varied and controlled to customize the deformation undergone by the transducer. More specifically, factors such as the relative elasticity between the polymer film and the electrode material, the relative thickness between the polymer film and electrode material and/or the varying thickness of the polymer film and/or electrode material, the physical pattern of the polymer film and/or electrode material (to provide localized active and inactive areas), the tension or pre-strain placed on the electroactive polymer film as a whole, and the amount of voltage applied to or capacitance induced upon the film may be controlled and varied to customize the features of the film when in an active mode.

Numerous applications exist that benefit from the advantages provided by such electroactive polymer films whether using the film alone or using it in an electroactive polymer actuator. One of the many applications involves the use of electroactive polymer transducers as actuators to produce haptic feedback (the communication of information to a user through forces applied to the user's body) in user interface devices.

Actuators comprising electroactive polymer materials may be configured to control the relative size of an aperture upon the application of an electric voltage potential to electrodes coupled to the electroactive polymer film. When the electroactive polymer material is not energized by an electric voltage potential, the aperture is defined by a first dimension and when the electroactive polymer material is energized by an electric voltage potential, the aperture is defined by a second dimension. The size of the aperture in the center of an electroactive polymer actuator may thus be controlled. Nevertheless, using this approach, the aperture limits the amount of restoring force that the electroactive polymer film can exert and potentially adds stress to the material around the aperture and can cause non-uniform film geometry when it is under the influence of an electric field (voltage).

### SUMMARY OF THE INVENTION

Electroactive polymer actuated aperture devices include, but are not limited to planar, diaphragm, thickness mode, roll, and passive coupled devices (hybrids) as well as any type of electroactive polymer device described in the commonly assigned patents and applications cited herein.

In one embodiment, an electroactive device comprises an electroactive polymer film defining an aperture. The aperture undergoes a deformation when an electric voltage potential is applied to electrodes coupled to the electroactive polymer film. In one embodiment, the electroactive polymer film is pre-tensioned. In one embodiment, elastomer reinforcement elements or rings are applied to top and/or bottom portions of the electroactive polymer film about the aperture.

In one embodiment, an apparatus is provided. The apparatus comprises a rigid frame; an electroactive polymer film defining an aperture, the electroactive polymer film having a first and second side; a first electrode located on the first side of the electroactive polymer film; and a second electrode located on the second side of the electroactive polymer film. The aperture is configured to deform upon the application of an electric voltage potential to the first and second electrodes.

In another embodiment, a method of making an electroactive device is provided. The method comprises positioning an electroactive polymer film within a rigid frame; and forming an aperture within the electroactive polymer film.

In another embodiment, an apparatus is provided. The apparatus comprises a rigid frame; a first diaphragm; a second diaphragm attached to the first diaphragm; and an aperture defined at a center portion of the first and second diaphragms.

These and other features, objects and advantages of the invention will become apparent to those persons skilled in the art upon reading the details of the invention as more fully described below. In addition, variations of the processes and devices described herein include combinations of the embodiments or of aspects of the embodiments where possible are within the scope of this disclosure even if those combinations are not explicitly shown or discussed.

### BRIEF DESCRIPTION OF THE DRAWINGS

The invention is best understood from the following detailed description when read in conjunction with the accompanying drawings. To facilitate understanding, the same reference numerals have been used (where practical) to designate similar elements are common to the drawings. Included in the drawings are the following:

FIGS. 1A and 1B illustrate a top perspective view of an electroactive device before and after application of a voltage to electrodes in accordance with one embodiment of the present invention;

FIGS. 2A-2D illustrate various steps associated with a process of making an electroactive device comprising a pre-tensioned aperture formed within a pre-tensioned electroactive polymer film in accordance with one embodiment of the present invention, where:

FIG. 2A illustrates a side sectional view of a pre-tensioned electroactive polymer film positioned within a rigid frame in accordance with one embodiment of the present invention;

FIG. 2B illustrates electrodes applied to both sides of the pre-tensioned electroactive polymer film shown in FIG. 2A in accordance with one embodiment of the present invention;

FIG. 2C illustrates pre-tensioned rings applied to both sides of the pre-tensioned electroactive polymer film shown in FIG. 2B in accordance with one embodiment of the present invention; and

FIG. 2D illustrates an aperture defined within the pre-tensioned rings of the electroactive polymer film shown in FIG. 2C in accordance with one embodiment of the present invention;

FIG. 3 illustrates a top view of a pre-tensioned electroactive device having a circular rigid frame and electroactive polymer film defining an aperture within pre-tensioned rings in accordance with one embodiment of the present invention;

FIGS. 4A-4B illustrate top views of a pre-tensioned electroactive device having a suitably shaped rigid frame and electroactive polymer film before and after application of an electric voltage potential to electrodes indicating contraction of the inner rings in accordance with one embodiment of the present invention;

FIGS. 5A-5B illustrate side sectional views of the pre-tensioned electroactive device shown in FIGS. 4A-4B before and after application of an electric voltage potential indicating contraction of the inner rings in accordance with one embodiment of the present invention;

FIGS. 6A-6B illustrate top view images of a pre-tensioned electroactive device before and after application of an electric voltage potential indicating contraction of the inner ring in accordance with one embodiment of the present invention;

FIGS. 7A-7B illustrate top view images of a 25% pre-tensioned electroactive device before and after application of an electric voltage potential of 500 V indicating contraction of the inner rings in accordance with one embodiment of the present invention;

FIGS. 8A-8B illustrate top view images of a 25% pre-tensioned electroactive device before and after application of an electric voltage potential of 730 V indicating contraction of the inner rings in accordance with one embodiment of the present invention;

FIGS. 9A-9B illustrate top view images of a 25% pre-tensioned electroactive device before and after application of an electric voltage potential of 1000 V indicating contraction of the inner rings in accordance with one embodiment of the present invention;

FIGS. 10A-10B are graphical illustrations of a cross-sectional model of an electroactive device before and after application of an electric voltage potential to electrodes indicating contraction of the inner rings in accordance with one embodiment of the present invention;

FIG. 11 illustrates a graphical representation of radius change versus prestrain applied to a pre-tensioned electroactive device before and after application of an electric voltage potential to electrodes in accordance with one embodiment of the present invention;

FIG. 12 illustrates a graphical representation of radius change versus prestrain and voltage applied to a pre-tensioned electroactive device before and after application of a voltage potential to electrodes in accordance with one embodiment of the present invention;

FIG. 13 illustrates an electroactive device comprising a pre-tensioned aperture formed within a pre-tensioned electroactive polymer film coupled to a rigid frame and electrically coupled to a flex circuit in accordance with one embodiment of the present invention;

FIG. 14 illustrates a perspective sectional view of a double diaphragm comprising a pattern of individually addressable electroactive portions and an aperture formed in a center portion thereof in accordance with one embodiment of the present invention;

FIG. 15 illustrates a top view of the double diaphragm shown in FIG. 14 in accordance with one embodiment of the present invention.

Variation of the invention from that shown in the figures is contemplated.

### DETAILED DESCRIPTION OF THE INVENTION

Examples of electroactive polymer devices and their applications are described, for example, in U.S. Pat. Nos. 7,394,282; 7,378,783; 7,368,862; 7,362,032; 7,320,457; 7,259,503; 7,233,097; 7,224,106; 7,211,937; 7,199,501; 7,166,953; 7,064,472; 7,062,055; 7,052,594; 7,049,732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971; 6,343,129; 7,952,261; 7,911,761; 7,492,076; 7,761,981; 7,521,847; 7,608,989; 7,626,319; 7,915,789; 7,750,532; 7,436,099; 7,199,501; 7,521,840; 7,595,580; 7,567,681; 7,595,580; 7,608,989; 7,626,319; 7,750,532; 7,761,981; 7,911,761; 7,915,789; 7,952,261; 8,183,739; 8,222,799; 8,248,750, and in U.S. Patent Application Publication Nos. 2007/0200457; 2007/0230222; 2011/0128239; and 2012/0126959, the entireties of which are incorporated herein by reference.

In various embodiments, the present invention provides an electroactive device comprising an electroactive polymer film defining an aperture. The aperture undergoes a deformation upon the application of an electric voltage potential to electrodes coupled to the electroactive polymer film. In one embodiment, the electroactive polymer film is pre-tensioned. In another embodiment, a portion of the electroactive polymer film may be removed to define the aperture. In one embodiment, elastomer reinforcement elements or rings are applied to top and/or bottom portions of the electroactive polymer film about the aperture. In one embodiment, the rings are applied to the electroactive polymer film after the film is pre-tensioned. In one embodiment, the aperture may be formed after the rings are applied to the electroactive polymer film.

It is noted that the figures discussed herein schematically illustrate exemplary configurations of devices and processes that employ electroactive polymer films or transducers having such electroactive polymer films. Many variations are within the scope of this disclosure, for example, in variations of the device, the electroactive polymer transducers can be implemented to control the size of apertures having varying geometries.

In any application, the displacement created by the electroactive polymer transducer can be exclusively in-plane which is sensed as lateral movement, or can be out-of-plane (which is sensed as vertical displacement). Alternatively, the electroactive polymer transducer material may be segmented to provide independently addressable/movable sections so as to provide angular displacement of the housing or electronic media device or combinations of other types of displacement. In addition, any number of electroactive polymer transducers or films (as disclosed in the applications and patent listed herein) can be incorporated in the aperture devices described herein.

The electroactive polymer transducer may be configured to displace upon the application of an electric voltage potential, which facilitates programming the size of an aperture for use with a control system with feedback devices. Electroactive polymer transducers are ideal for many such applications for a number of reasons. For example, because of their light weight and minimal components, electroactive polymer transducers offer a very low profile and, as such, are ideal for use in sensory/haptic/optical feedback applications.

Embodiments of the present invention may be manufactured using various processes.

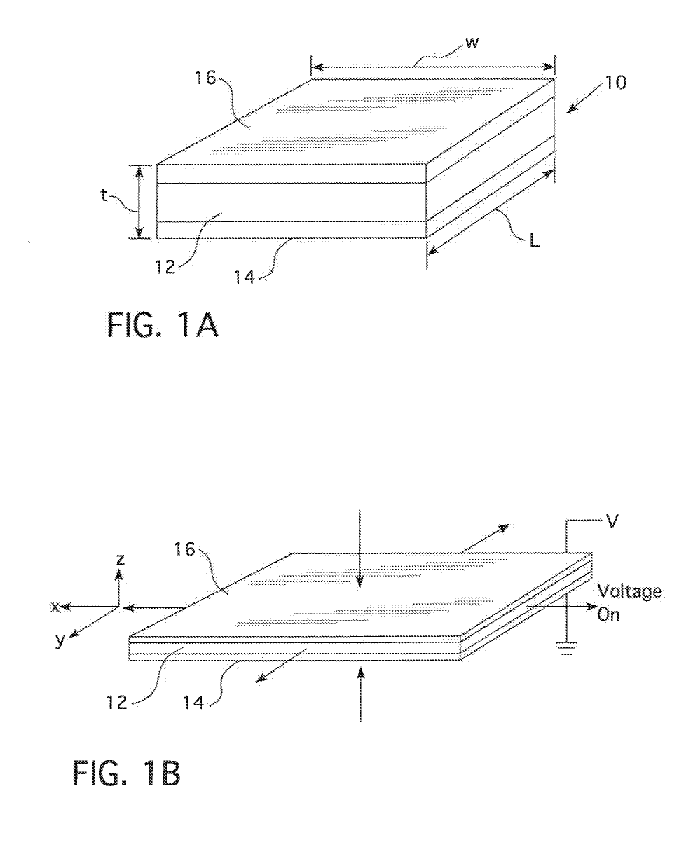

Various embodiments of electroactive polymer transducers or devices for controlling the size of an aperture are described in detail hereinbelow. Prior to describing such embodiments, however, FIGS. 1A-1B illustrate a top perspective view of an electroactive device before and after application of an electric voltage potential to electrodes in accordance with one embodiment of the present invention and provide a brief description of general electroactive polymer structures and processes for producing such structures.

Accordingly, the description now turns to FIGS. 1A and 1B, which illustrate an example of an electroactive polymer film or membrane 10 structure. A thin elastomeric dielectric film or layer 12 is sandwiched between compliant or stretchable electrode plates or layers 14 and 16, thereby forming a capacitive structure or film. The length “I” and width “w” of the dielectric layer, as well as that of the composite structure, are much greater than its thickness “t”. Preferably, the dielectric layer has a thickness in the range from about 10 μm to about 100 μm, with the total thickness of the structure in the range from about 15 μm to about 10 cm. Additionally, it is desirable to select the elastic modulus, thickness, and/or the geometry of electrodes 14, 16 such that the additional stiffness they contribute to the actuator is generally less than the stiffness of the dielectric layer 12, which has a relatively low modulus of elasticity, i.e., less than about 100 MPa and more preferably less than about 10 MPa, but is likely thicker than each of the electrodes. Electrodes suitable for use with these compliant capacitive structures are those capable of withstanding cyclic strains greater than about 1% without failure due to mechanical fatigue.

As seen in FIG. 1B, when a voltage is applied across the electrodes, the unlike charges in the two electrodes 14, 16 are attracted to each other and these electrostatic attractive forces compress the dielectric film 12 (along the Z-axis). The dielectric film 12 is thereby caused to deflect with a change in electric field. As electrodes 14, 16 are compliant, they change shape with dielectric layer 12. In the context of the present disclosure, “deflection” refers to any displacement, expansion, contraction, torsion, linear or area strain, or any other deformation of a portion of dielectric film 12. Depending on the architecture, e.g., a frame, in which capacitive structure 10 is employed (collectively referred to as a “transducer”), this deflection may be used to produce mechanical work. Various different transducer architectures are disclosed and described in the above-identified patent references.

With a voltage applied, the transducer film 10 continues to deflect until mechanical forces balance the electrostatic forces driving the deflection. The mechanical forces include elastic restoring forces of the dielectric layer 12, the compliance or stretching of the electrodes 14, 16 and any external resistance provided by a device and/or load coupled to transducer 10. The resultant deflection of the transducer 10 as a result of the applied voltage may also depend on a number of other factors such as the dielectric constant of the elastomeric material and its size and stiffness. Removal of the voltage difference and the induced charge causes the reverse effects.

In some cases, the electrodes 14 and 16 may cover a limited portion of dielectric film 12 relative to the total area of the film. This may be done to prevent electrical breakdown around the edge of the dielectric or achieve customized deflections in certain portions thereof. Dielectric material outside an active area (the latter being a portion of the dielectric material having sufficient electrostatic force to enable deflection of that portion) may be caused to act as an external spring force on the active area during deflection. More specifically, material outside the active area may resist or enhance active area deflection by its contraction or expansion.

The dielectric film 12 may be pre-strained. The pre-strain improves conversion between electrical and mechanical energy, i.e., the pre-strain allows the dielectric film 12 to deflect more and provide greater mechanical work. Pre-strain of a film may be described as the change in dimension in a direction after pre-straining relative to the dimension in that direction before pre-straining. The pre-strain may include elastic deformation of the dielectric film and be formed, for example, by stretching the film in tension and fixing one or more of the edges while stretched. The pre-strain may be imposed at the boundaries of the film or for only a portion of the film and may be implemented by using a rigid frame or by stiffening a portion of the film.

The transducer structure of FIGS. 1A and 1B and other similar compliant structures and the details of their constructs are more fully described in many of the referenced patents and publications disclosed herein. The following description now turns to various embodiments of electroactive devices for varying the size of or deforming an aperture defined within a pre-tensioned electroactive polymer film constrained on its perimeter edges by a rigid frame.

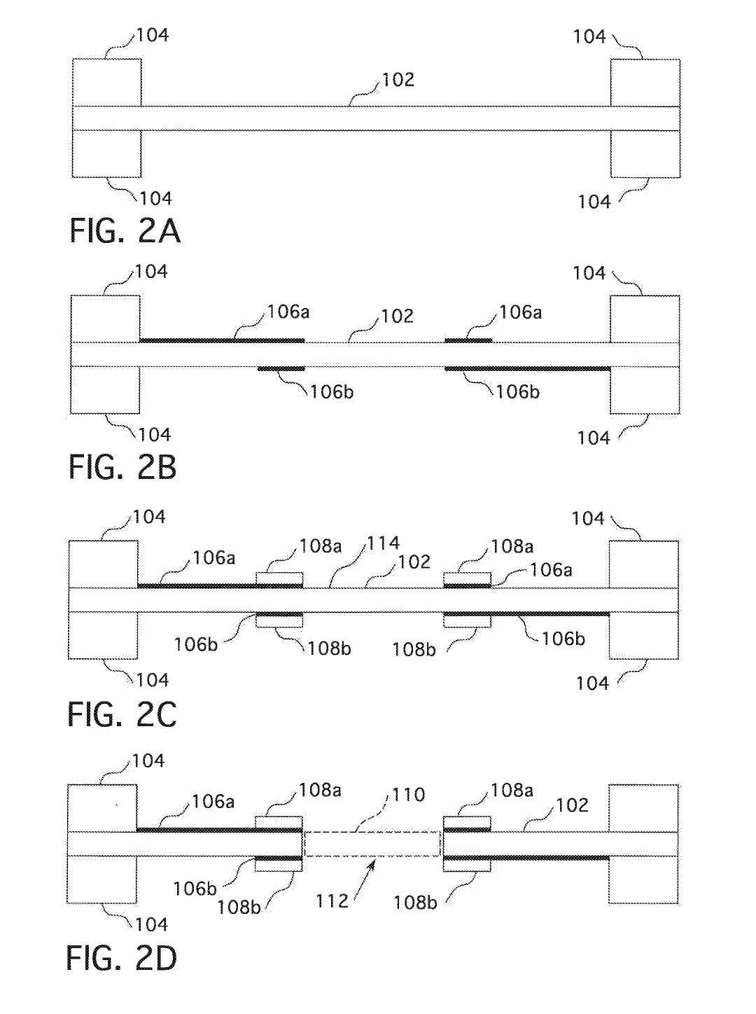

Accordingly, FIGS. 2A-2D illustrate various steps associated with a process of making an electroactive device comprising a pre-tensioned aperture formed within a pre-tensioned electroactive polymer film in accordance with one embodiment of the present invention. In one embodiment, the process includes (1) laminating a printed electroactive polymer film on a liner to preserve the prestrain in the film during a cutting process; (2) cutting an aperture at a center portion of the laminated film with a laser, die or other suitable tools; and (3) removing the liner from the film.

FIG. 2A illustrates a side sectional view of a pre-tensioned electroactive polymer film 102 positioned within a rigid frame 104 in accordance with one embodiment of the present invention. As illustrated in FIG. 2B, electrodes 106a, 106b are applied to both sides of the pre-tensioned electroactive polymer film 102 shown in FIG. 2A in accordance with one embodiment of the present invention. In one embodiment, the electrodes 106a, 106b may be applied to the electroactive polymer film 102 prior to pre-tensioning within the frame 104. Upon the application of an electric voltage potential to the electrodes 106a, 106b, the electrodes 106a, 106b attract each other and compress the pre-tensioned electroactive polymer film 102 therebetween. It will be appreciated that the electroactive polymer film 102 although shown as a single layer, may actually be implemented as a stack of multiple layers. In such stacked configurations, the electrodes 106a, 106b may be positioned on opposite outer sides of the stacked layers to compress the entire stacked layer of electroactive polymer films. In other stacked film configurations, the electrodes 106a, 106b may be embedded between any two layers electroactive polymer film. In other stacked film configurations electrodes 106a, 106b may be positioned on the outside of the two outer layers of the stacked film configuration while one or more other electrodes may be embedded between any two of the electroactive polymer film layers. Other stacked configurations are contemplated to be within the scope of the present invention.

As illustrated in FIG. 2C, pre-tensioned rings 108a, 108b are applied to both sides of the pre-tensioned electroactive polymer film 102 shown in FIG. 2B in accordance with one embodiment of the present invention. In one embodiment, the pre-tensioned elastomeric rings 108a, 108b are applied to the top and bottom portions of the electroactive polymer film 102 and define a center portion 114 within the rings 108a, 108b that will be cut out or otherwise removed to define an aperture. The pre-tensioned elastomeric rings 108a, 108b provide restoring force, reduce stresses, and reduce non-uniform geometry when an electric voltage potential is applied to the electrodes 106a, 106b. In one embodiment, the elastomeric rings 108a, 108b may be applied to the electroactive polymer film prior to cutting the center portion 114 in the film 102 to define an aperture.

FIG. 2D illustrates an aperture 112 defined within the pre-tensioned rings 108a, 108b of the electroactive polymer film 102 shown in FIG. 2C in accordance with one embodiment of the present invention. Although the use of a transparent or translucent electroactive polymer film enables some light-control aperture applications, those skilled in the art will recognize that other applications may require an opening in the film. Accordingly, the aperture 112 is formed by cutting a film slug 110 (shown in phantom) within the center portion 114 of the rings 108a, 108b. Pre-tensioning the rings 108a, 108b, preserves or retains the uniformly tensioned properties of the electroactive polymer film 102 after the film slug 110 is cut from the pre-tensioned film 102 to define the aperture 112. It will be appreciated that by pre-tensioning the rings 108a, 108b and the film 102, the “rings” 108a, 108b and the aperture 112 are not constrained to being circular in shape. Also, because the “rings” 108a, 108b equalize the forces on the film 102, it becomes possible to make different shaped aperture cutouts in the film 102 without having the stress concentrations that cause tearing in the film 102. Accordingly, the “rings” 108a, 108b and the aperture 112 may be formed in any suitable shape including, without limitation, round, elliptical, oblong, square, rectangular, triangular, hexagonal, or any other suitable polygonal shape, among others. In various embodiments, the inside corners of any of the square, rectangular, triangular, hexagonal, or other suitable polygonal shapes, may be rounded to avoid tearing the film where otherwise sharp corners would be defined.

As the electroactive polymer film 102 is stretched biaxially over a circular aperture 112, the film is coated on both sides with an electrode 106a, 106b layer. These layers can be in a variety of shapes, whether toroidal, circular, or elliptical. The aperture 112 is formed or cut in the center of the film 102 to improve radial contraction. When a differential electric voltage potential is applied to the top and bottom electrodes 106a, 106b, the electroactive polymer film 102 deforms and contracts inwardly toward the center of the aperture to reduce the overall size (e.g., radius or diameter) of the aperture 112. Upon the application of an electric voltage potential to the electrodes 106a, 106b the film 102 compresses vertically to provide the necessary radial forces to hold the aperture 112 at a predetermined diameter. Such configuration allows the aperture 112 to contract and expand more rapidly and in a thinner plane.

In one embodiment, the present invention retains the uniform tension of the electroactive polymer film 102, as if there was no aperture 112 formed in the film 102, while creating a clear optical path through the missing or removed film area (i.e., the aperture 112). This uniform tension eliminates or mitigates high hoop stresses at the edge of the aperture 112 that cause wrinkling of the film 102 under actuation forces and enables the desired size of the aperture 112 to be more accurately maintained before and during operation. The present technique provides a clear optical path through the center of the actuator by virtue of the aperture 112 and avoids or minimizes stresses around the edges of the aperture 112 that causes the film 102 to wrinkle or otherwise deform in a non desirable manner during actuation when an electric voltage potential is applied to the electrodes 106a, 106b on the film 102.

Electroactive devices comprising an actuatable aperture may be employed in various applications to create an electroactive polymer aperture 112 for thin devices such as camera lens, optical aperture systems, fluid flow control, or any other applications where it would be desirable to control an aperture to regulate or change a quantity of light, fluid such as air, liquid, or even solid material, passing through the aperture 112. Camera systems currently provided in mobile phones and tablets, for example, require the devices to be a certain depth, and using thinner parts could lead to a reduction in overall thickness. In one embodiment the aperture may be employed to determine a cone angle of a bundle of light rays that come to a focus in the image plane. The size of the opening can be controlled with voltage applied to the electroactive film electrodes. In one embodiment, the aperture may be employed with optical devices to control the light input onto an imaging chip (or film). Other applications are contemplated to be within the scope of the present invention.

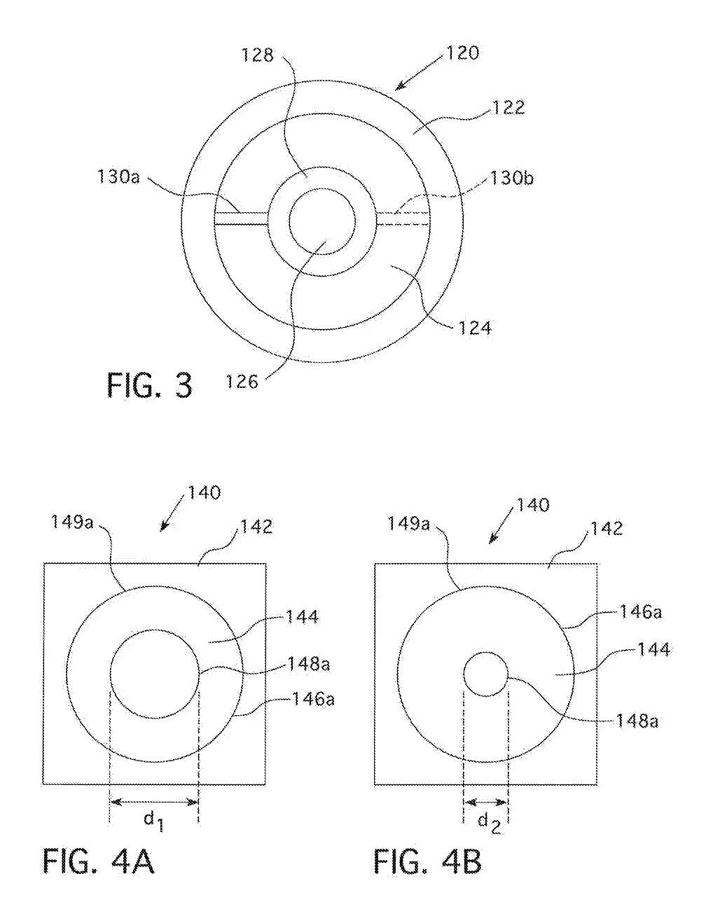

FIG. 3 illustrates a top view of a pre-tensioned electroactive device 120 comprising a circular rigid frame 122 in accordance with one embodiment of the present invention. An electroactive polymer film 124 defines an aperture 126 within pre-tensioned rings 128 in accordance with one embodiment of the present invention. Electrodes 130, 130b located above and below the film 124 are configured to receive an electric voltage potential. Upon actuation by the electric voltage potential the electrodes 130a, 130b compress the film 124 to cause radial contraction of the aperture 126 relative to the size of the aperture 126 radius with no application of the electric voltage potential to the electrodes 130a, 130b.

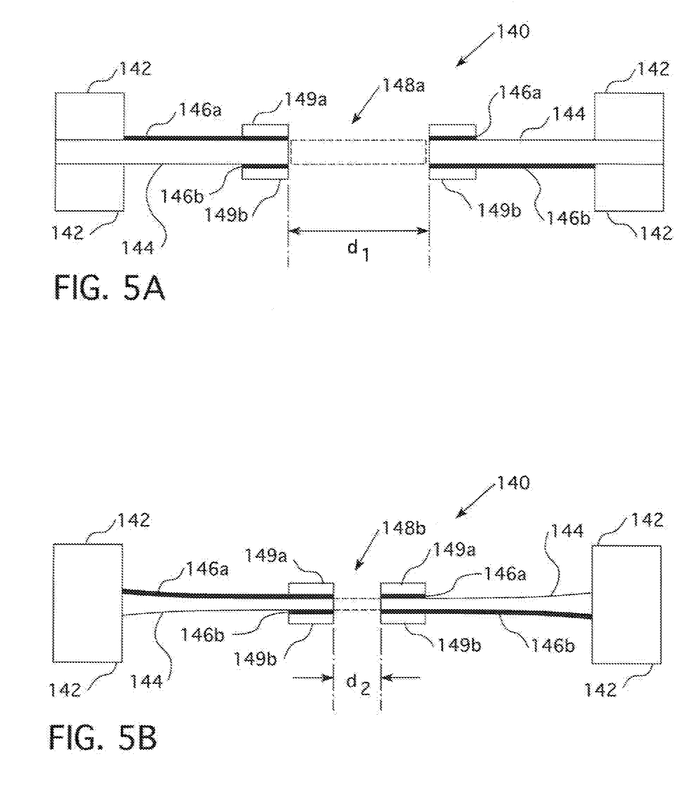

FIGS. 4A-4B illustrate top views of a pre-tensioned electroactive device 140 before and after application of an electric voltage potential to electrodes indicating contraction of the inner ring 149a, 149b (FIGS. 5A-5B) in accordance with one embodiment of the present invention. The electroactive device 140 comprises a suitably shaped rigid frame 142 to capture an electroactive polymer film 144 with electrodes 146a, 146b (FIGS. 5A-5B) provided on each side of the film 144. FIG. 4A illustrates the pre-tensioned electroactive device 140 in an inactive state before the application of a voltage potential to the electrodes 146a, 146b and defines an aperture 148a having a first diameter d₁ within the pre-tensioned rings. FIG. 4B illustrates the pre-tensioned electroactive device 140 shown in FIG. 4A in an active state after the application of a voltage to the electrodes 146a, 146b and defines an aperture 148b having a second diameter d₂ within the pre-tensioned rings 149a, 149b, where d₁>d₂.

FIGS. 5A-5B illustrate side sectional views of the pre-tensioned electroactive device 140 shown in FIGS. 4A-4B before and after application of an electric voltage potential to electrodes 146a, 146b indicating contraction of the inner rings 149a, 149b in accordance with one embodiment of the present invention. The electroactive device 140 comprises a suitably shaped rigid frame 142 to capture an electroactive polymer film 144 with electrodes 146a, 146b provided on both sides of the film 144. FIG. 5A illustrates the pre-tensioned electroactive device 140 in an inactive state before the application of a voltage to the electrodes 146a, 146b and defines an aperture 148a having a first diameter d₁ within the pre-tensioned rings 149a, 149b. FIG. 5A illustrates the electroactive device 140 shown in FIG. 5B in an active state after the application of a voltage to the electrodes 146a, 146b and defines an aperture 148b having a second diameter d₂ within the pre-tensioned rings, where d₁>d₂.

As previously discussed, the two electrodes 146a, 146b have deformable characteristics and are separated by the thin electroactive polymer film 144. When a voltage potential difference is applied to the electrodes 146a, 146b, the oppositely charged electrodes 146a, 146b attract each other thereby compressing the electroactive polymer film 144 layer therebetween, as shown in FIG. 5B, for example. As the electrodes 146a, 146b are pulled closer together, the dielectric polymer film 144 becomes thinner (the Z-axis component contracts) as it expands in the planar directions (along the X- and Y-axes), i.e., the displacement of the film 144 is in-plane.

The material and physical properties of the electroactive polymer film 144 may be varied and controlled to customize the deformation undergone by the electroactive 140. More specifically, factors such as the relative elasticity between the polymer film 144 and the electrodes 146a, 146b material, the relative thickness between the polymer film 144 and electrodes 146a, 146b material and/or the varying thickness of the polymer film 144 and/or electrodes 146a, 146b material, the physical pattern of the polymer film 144 and/or electrodes 146a, 146b material (to provide localized active and inactive areas), the tension or pre-strain placed on the electroactive polymer film 144 as a whole, and the amount of voltage potential applied to or capacitance induced upon the film 144 may be controlled and varied to customize the features of the film 144 when in an active mode.

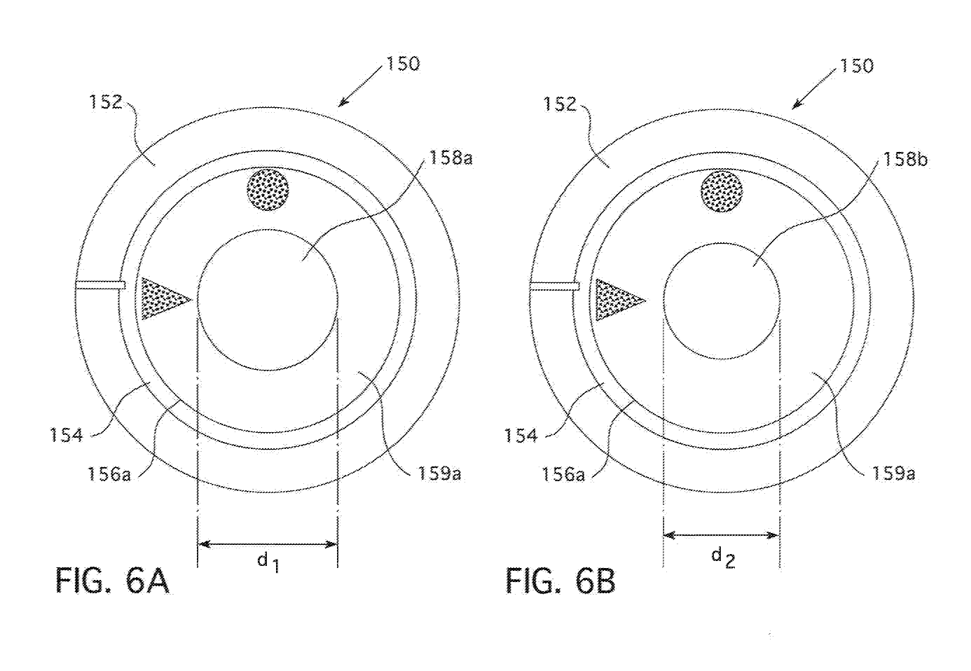

FIGS. 6A-6B illustrate top view images of a pre-tensioned electroactive device 150 before and after application of an electric voltage potential to electrodes indicating contraction of the inner rings in accordance with one embodiment of the present invention. As only the top view images of the pre-tensioned electroactive device 150 are shown, the FIGS. 6A-6B illustrate only the top side electrode 156a and the top side ring 159a. In accordance with the description of FIGS. 2D, 5A, 5B, however, it will be appreciated that the pre-tensioned electroactive device 150 comprises a bottom side electrode 156b (not shown) and a bottom side ring 159b (not shown). The electroactive device 150 comprises a suitably shaped rigid frame 152 to capture an electroactive polymer film 154 with electrodes 156a, 156b (bottom side electrode 156b not shown) provided on both sides of the film 154. FIG. 6A illustrates the pre-tensioned electroactive device 150 in an inactive state before the application of an electric voltage potential to the electrodes 156a, 156b and defines an aperture 158a having a first diameter d₁ within the pre-tensioned rings 159A, 159b (bottom side ring 159b not shown). FIG. 6B illustrates a top view image of the pre-tensioned electroactive device 150 shown in FIG. 6A in an active state after the application of an electric voltage potential to the electrodes 156a, 156b and defines an aperture 158b having a second diameter d₂ within the pre-tensioned rings 159a, 159b, where d₁>d₂.

Still with reference to FIGS. 6A-6B, in one example, in the absence of an applied electric voltage potential to the electrodes 156a, 156b the diameter d₁ of the aperture 158a is approximately 4669 m and upon the application of an electric voltage potential to the electrodes 156a, 156b the diameter d₂ of the aperture 158b is approximately 4150 μm for a change in aperture size of about −519 μm.

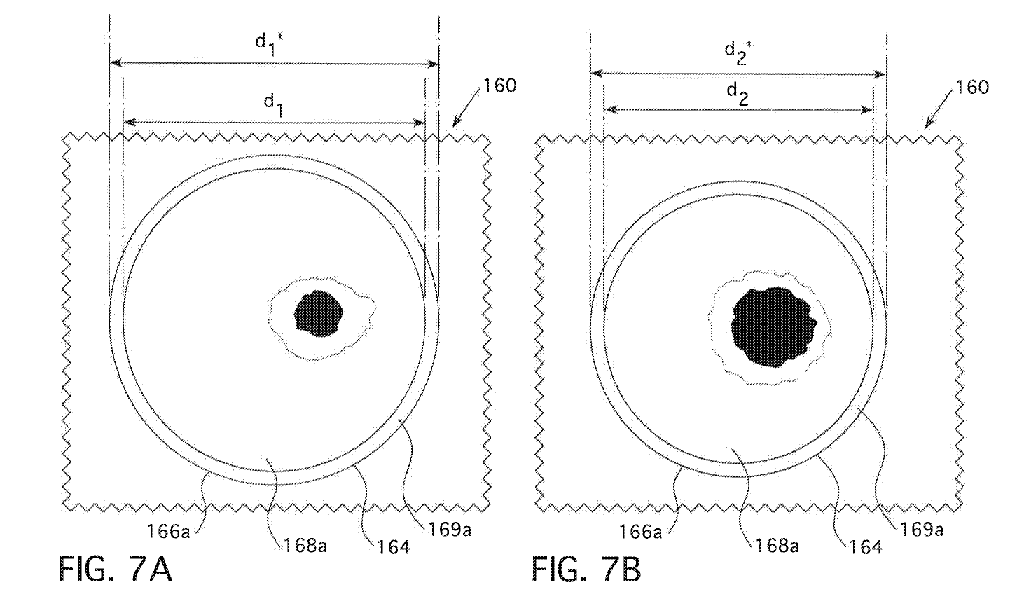

FIGS. 7A-7B illustrate top view images of a 25% pre-tensioned electroactive device 160 before and after application of an electric voltage potential of 500 V to electrodes indicating contraction of the inner rings in accordance with one embodiment of the present invention. As only the top view images of the pre-tensioned electroactive device 160 are shown, FIGS. 7A-7B illustrate only the top side electrode 166a and the top side ring 169a. The electroactive device 160 comprises a rigid frame to capture an electroactive polymer film 164 with electrodes 166a, 166b (bottom side electrode 166b not shown) provided on both sides of the film 164. FIG. 7A illustrates a top view image of a 25% pre-tensioned electroactive device 160 in an inactive state before application of an electric voltage potential to the electrodes 166a, 166b and defines an aperture 168a having a first diameter d₁ within the pre-tensioned rings (bottom side ring 169b not shown). FIG. 7B illustrates a top view image of the 25% pre-tensioned electroactive device shown in FIG. 7A in an active state after the application of an electric voltage potential of 500 V to the electrodes 166a, 166b and defines an aperture 168b having a second diameter d₂ within the pre-tensioned rings 169a, 169b, where d₁>d₂. Furthermore, the inner diameter of the rings 169a, 169b also undergoes a deformation from d₁′ to d₂′ upon the application of an electric voltage potential of 500 V to the electrodes 166a, 166b.

Still with reference to FIGS. 7A-7B, in one example, in the absence of an applied electric voltage potential to the electrodes 166a, 166b the diameter d₁ of the aperture 168a is approximately 5361 μm and upon the application of an electric voltage potential of 500 V to the electrodes 166a, 166b the diameter d₂ of the aperture 168b is approximately 4865 μm for a change in aperture size of about −496 μm. Also, in the absence of an applied electric voltage potential to the electrodes 166a, 166b the inner diameter d₁′ of the rings 169a, 169b is approximately 5879 μm and upon the application of an electric voltage potential of 500 V to the electrodes 166a, 166b the inner diameter d₂′ of the rings 169a, 169b is approximately 5383 μm for a change in aperture size of about −496 μm.

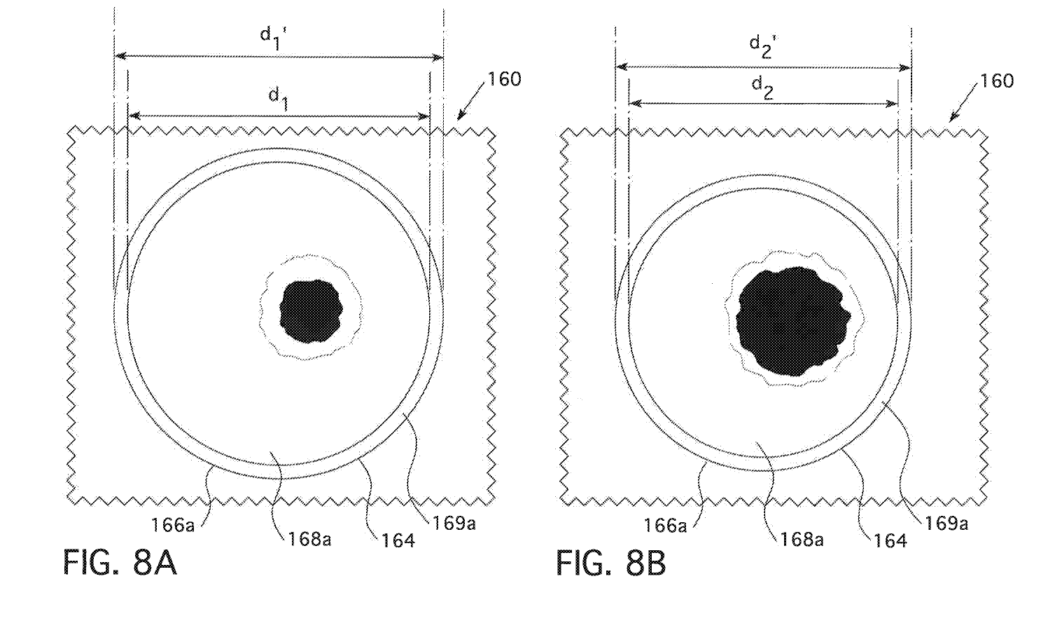

FIGS. 8A-8B illustrate top view images of a 25% pre-tensioned electroactive device 160 before and after application of an electric voltage potential of 730 V to electrodes indicating contraction of the inner rings in accordance with one embodiment of the present invention. Since only the top view images of the pre-tensioned electroactive device 160 are shown, FIGS. 8A-8B illustrate only the top side electrode 166a and the top side ring 169a. The electroactive device 160 comprises a rigid frame to capture an electroactive polymer film 164 with electrodes 166a, 166b (bottom side electrode 166b not shown) provided on both sides of the film 164. FIG. 8A illustrates a top view image of a 25% pre-tensioned electroactive device 160 in an inactive state before application of an electric voltage potential of 730 V to the electrodes 166a, 166b and defines an aperture 168a having a first diameter d₁ within the pre-tensioned rings (bottom side ring 169b not shown). FIG. 8B illustrates a top view image of the 25% pre-tensioned electroactive device shown in FIG. 8A in an active state upon the application of an electric voltage potential of 730 V to the electrodes 166a, 166b and defines an aperture 168b having a second diameter d₂ within the pre-tensioned rings 169a, 169b.

Still with reference to FIGS. 8A-8B, in one example, in the absence of an applied electric voltage potential to the electrodes 166a, 166b the diameter d₁ of the aperture 168a is approximately 5334 μm and upon the application of an electric voltage potential of 730 V to the electrodes 166a, 166b the diameter d₂ of the aperture 168b is approximately 4511 μm for a change in aperture size of about −823 μm. Also, in the absence of an applied electric voltage potential to the electrodes 166a, 166b the inner diameter d₁′ of the rings 169a, 169b is approximately 5835 μm and upon the application of an electric voltage potential of 730 V to the electrodes 166a, 166b the inner diameter d₂′ of the rings 169a, 169b is approximately 5012 μm for a change in aperture size of about −823 μm.

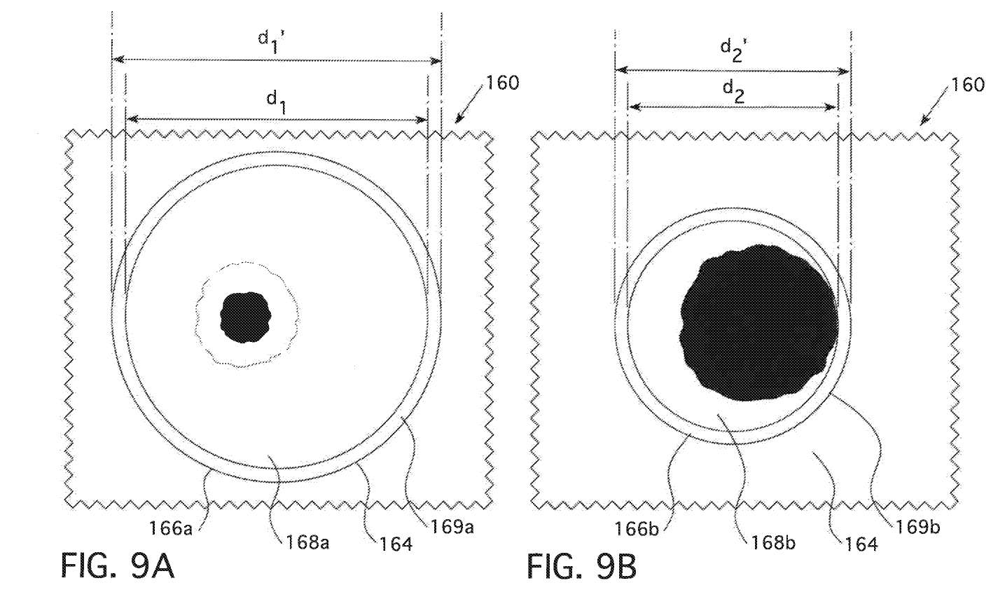

FIGS. 9A-9B illustrate top view images of a 25% pre-tensioned electroactive device 160 before and after application of an electric voltage potential of 1000 V to electrodes indicating contraction of the inner rings in accordance with one embodiment of the present invention. Since only the top view images of the pre-tensioned electroactive device 160 are shown, FIGS. 9A-9B illustrate only the top side electrode 166a and the top side ring 169a. The electroactive device 160 comprises a rigid frame to capture an electroactive polymer film 164 with electrodes 166a, 166b (bottom side electrode 166b not shown) provided on both sides of the film 164. FIG. 9A illustrates a top view image of a 25% pre-tensioned electroactive device 160 in an inactive state before application of an electric voltage potential to the electrodes 166a, 166b and defines an aperture 168a having a first diameter d₁ within the pre-tensioned rings (bottom side ring 169b not shown). FIG. 9B illustrates a top view image of the 25% pre-tensioned electroactive device shown in FIG. 9A in an active state after the application of an electric voltage potential of 1000V to the electrodes and defines an aperture 168b having a second diameter d₂ within the pre-tensioned rings 169a, 169b.

Still with reference to FIGS. 9A-9B, in one example, in the absence of an applied electric voltage potential to the electrodes 166a, 166b the diameter d₁ of the aperture 168a is approximately 5911 μm and upon the application of an electric voltage potential of 1000 V to the electrodes 166a, 166b the diameter d₂ of the aperture 168b is approximately 4424 μm for a change in aperture size of about −1469 μm.

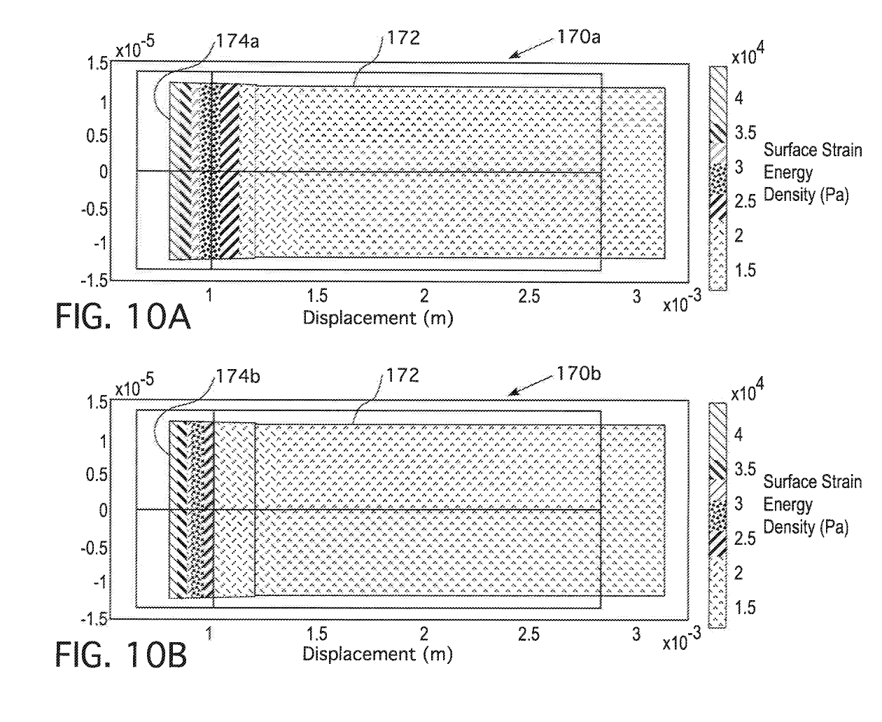

FIGS. 10A-10B are graphical illustrations 170a, 170b of a cross-sectional model 172 of an electroactive device before and after application of an electric voltage potential to electrodes indicating contraction of the inner ring in accordance with one embodiment of the present invention. The horizontal and vertical axes represent deformation displacement (m) and the various shadings represent surface strain energy density (Pa). FIG. 10A is a graphical illustration 170a of the cross-sectional model 172 before an electric voltage potential is applied to electrodes of the electroactive device. FIG. 10B is a graphical illustration 170b of the cross-sectional model 172 after an electric voltage potential is applied to the electroactive device. Note the leftward movement of the band 174b relative to the band 174a in FIG. 10A, indicating contraction of the inner ring and thus deformation of the aperture in accordance with embodiments of the present invention.

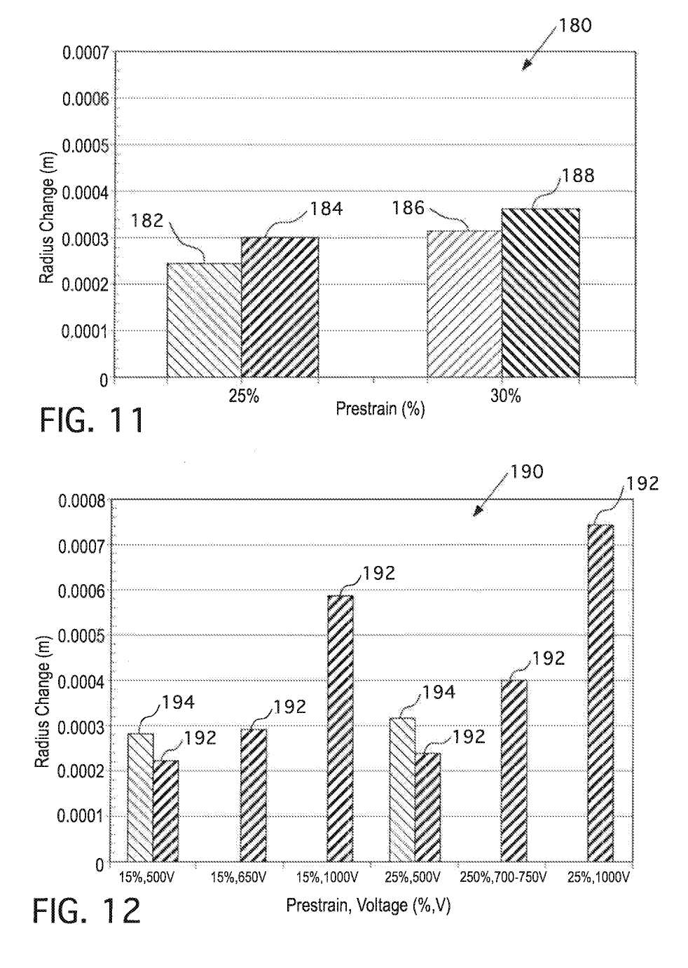

FIG. 11 illustrates a graphical representation 180 of radius change versus prestrain applied to a pre-tensioned electroactive device before and after application of a voltage potential to electrodes in accordance with one embodiment of the present invention. The horizontal axis represents percent (%) prestrain applied to the electroactive polymer film and the vertical axis represents the corresponding radius change (m) of an aperture when an electric voltage potential of 500 V is applied to the electroactive polymer film. At 25% prestrain, the bar 182 on the left represents the radius change of a model electroactive device with a 500 V electric voltage potential applied to electrodes and the bar 184 on the right represents the radius change of an actual electroactive device with a 500 V electric voltage potential applied to the electrodes. At 30% prestrain, the bar 186 on the left represents the radius change of a model electroactive device with a 500 V electric voltage potential applied to the electrodes and the bar 188 on the right represents the radius change of an actual electroactive device with a 500 V electric voltage potential applied to the electrodes. As illustrated by the graphical representation 180, the size of the deformation of the aperture radius increases with increasing prestrain percentage applied to the electroactive polymer film.

FIG. 12 illustrates a graphical representation 190 of radius change versus prestrain percentage and electric voltage potential applied to the pre-tensioned electroactive polymer film before and after application of a voltage potential to electrodes in accordance with one embodiment of the present invention. The horizontal axis represents percent prestrain (%) and voltage (V) applied to the electroactive polymer film and the vertical axis represents the corresponding radius change (m) when a voltage potential is applied to the electroactive polymer film. The bars labeled 192 represent an actual electroactive polymer device tested and the bars labeled 194 represent a model electroactive polymer device. As illustrated by the graphical representation 190, the size of the deformation of the aperture radius increases with increasing prestrain percentage applied to the electroactive polymer film as also illustrated by the graphical representation 180 in FIG. 11. As illustrated in FIG. 12, for a given percentage prestrain applied to the electroactive polymer film, the size of the deformation of the aperture radius increases with increasing electric voltage potential applied to the electroactive polymer film.

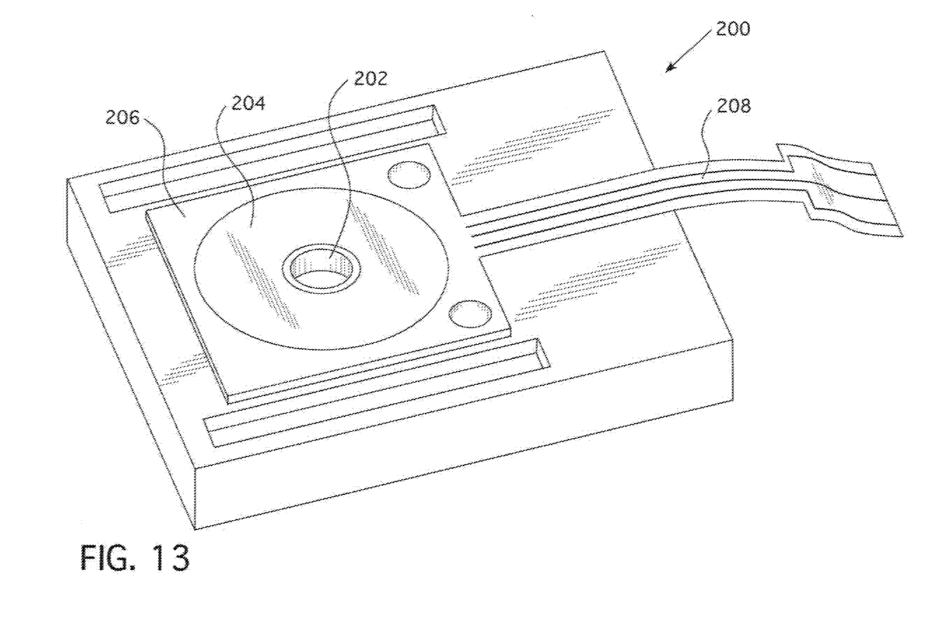

FIG. 13 illustrates an electroactive device 200 comprising a pre-tensioned aperture 202 formed within a pre-tensioned electroactive polymer film 204 coupled to a rigid frame 206 and electrically coupled to a flex circuit 208 in accordance with one embodiment of the present invention. The flex circuit 208 electrically couples the electrodes to a source of electric voltage potential to activate the electroactive device 200 and deform the aperture 202 upon the application of an electric voltage potential to the electrodes.

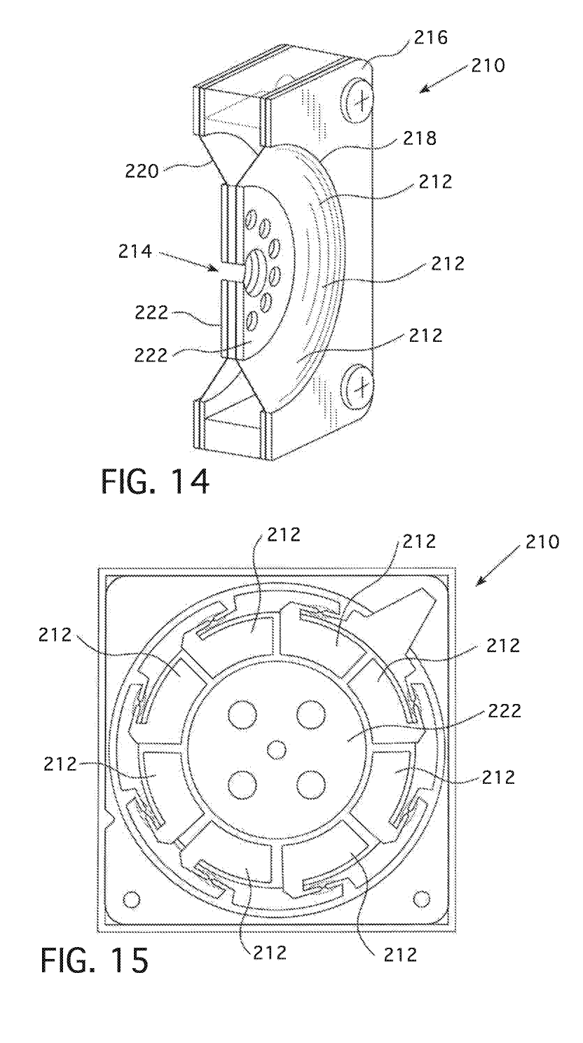

FIG. 14 illustrates a perspective sectional view of a double diaphragm electroactive polymer device 210 comprising a pattern of individually addressable electroactive portions 212 and an aperture 214 formed in a center portion thereof in accordance with one embodiment of the present invention. The double diaphragm 210 comprises a rigid frame 216 and first and second diaphragms 218, 220 attached to the rigid frame 216. The first and second diaphragms 218, 220 are connected in a central region 222 such that each of the diaphragms 218, 220 defines a frustum. The aperture 214 is provided in the central region 222. The solid black area comprises a pattern of individually addressable electroactive portions 212 of electroactive polymer as shown in FIG. 15. Application of a voltage potential to the individually addressable electroactive portions 212 of electroactive polymer causes the aperture 214 to deform. Lenses also can be mounted onto the structural material of the double diaphragm 210 which can then be adjustable with the height of the frustum or tilted with respect to the plane of the outer frame 216 to enable changes in focal length, tilt, and pan functions. Image stabilization may be achieved when the lens/aperture are moved with an appropriate frequency. In one embodiment, the segmented electroactive portions 212 provide independently addressable/movable sections so as to provide angular displacement of the housing or electronic media device or combinations of other types of displacement.

FIG. 15 illustrates a top view of the double diaphragm 210 shown in FIG. 14 in accordance with one embodiment of the present invention. The individually addressable electroactive portions 212 shown in FIG. 14 define a pattern of individually addressable active areas 212 of electroactive polymer. The individually addressable electroactive portions 212 each comprise first and second electrodes to actuate the individually addressable electroactive portions 212 in response to an applied electric voltage potential to the electrodes.

As for other details of the present invention, materials and alternate related configurations may be employed as within the level of those with skill in the relevant art. The same may hold true with respect to process-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Stated otherwise, unless specifically defined herein, all technical and scientific terms used herein are to be given as broad a commonly understood meaning as possible while maintaining claim validity.

Various aspects of the subject matter described herein are set out in the following numbered clauses:

1. An apparatus, comprising: a rigid frame; an electroactive polymer film defining an aperture, the electroactive polymer film having a first and second side; a first electrode located on the first side of the electroactive polymer film; and a second electrode located on the second side of the electroactive polymer film; wherein the aperture is configured to deform upon the application of an electric voltage potential to the first and second electrodes.

2. The apparatus according to clause 1, wherein the electroactive polymer film comprises stacked layers of electroactive polymer film.

3. The apparatus according to clause 1, wherein the electroactive polymer film is pre-tensioned.

4. The apparatus according to clause 1, wherein a portion of the electroactive polymer film has been removed.

5. The apparatus according to clause 1, further comprising at least a first reinforcement element located on the first side of the electroactive polymer film.

6. The apparatus according to clause 5, wherein the reinforcement element is formed of an elastomeric material.

7. The apparatus according to clause 5, wherein the reinforcement element is pre-tensioned.

8. The apparatus according to clause 5, wherein the reinforcement element is configured to deform upon the application of the electric voltage potential to the first and second electrodes.

9. A method of making an electroactive device, the method comprising: positioning an electroactive polymer film within a rigid frame; applying a first electrode of a first side of the electroactive polymer film; applying a second electrode on a second side of the electroactive polymer film; and forming an aperture within the electroactive polymer film.

10. The method according to clause 9, further comprising pre-tensioning the electroactive polymer film prior to forming the aperture.

11. The method according to clause 9, further comprising stacking two or more layers of the electroactive polymer film.

12. The method according to clause 9, further comprising applying at least a first reinforcement element on a first side of the electroactive polymer film.

13. The method according to clause 12, wherein the aperture is formed within a central portion of the reinforcement element.

14. The method according to clause 12, further comprising pre-tensioning the reinforcement element prior to applying the pre-tensioned reinforcement element on the first side of the electroactive polymer.

15. An apparatus comprising: a rigid frame; a first diaphragm; a second diaphragm attached to the first diaphragm; and an aperture defined at a center portion of the first and second diaphragms.

16. The apparatus according to clause 15, wherein the first and second diaphragms each comprise individually addressable electroactive portions.

1. An apparatus, comprising:
a rigid frame;
an electroactive polymer film defining an aperture, the electroactive polymer film having a first and second side;
a first electrode located on the first side of the electroactive polymer film; and
a second electrode located on the second side of the electroactive polymer film;
wherein the aperture is configured to deform upon the application of an electric voltage potential to the first and second electrodes.

2. The apparatus according to claim 1, wherein the electroactive polymer film comprises stacked layers of electroactive polymer film.

3. The apparatus according to claim 1, wherein the electroactive polymer film is pre-tensioned.

4. The apparatus according to claim 1, wherein a portion of the electroactive polymer film has been removed.

5. The apparatus according to claim 1, further comprising at least one reinforcement element located on the first side of the electroactive polymer film.

6. The apparatus according to claim 5, wherein the at least one reinforcement element is formed of an elastomeric material.

7. The apparatus according to claim 5, wherein the at least one reinforcement element is pre-tensioned.

8. The apparatus according to claim 5, wherein the at least one reinforcement element is configured to deform upon the application of the electric voltage potential to the first and second electrodes.

9. A method of making an electroactive device, the method comprising:
positioning an electroactive polymer film within a rigid frame;
applying a first electrode of a first side of the electroactive polymer film;
applying a second electrode on a second side of the electroactive polymer film; and
forming an aperture within the electroactive polymer film.

10. The method according to claim 9, further comprising pre-tensioning the electroactive polymer film prior to forming the aperture.

11. The method according to claim 9, further comprising stacking two or more layers of the electroactive polymer film.

12. The method according to claim 9, further comprising applying at least one reinforcement element on a first side of the electroactive polymer film.

13. The method according to claim 9, wherein the aperture is formed within a central portion of the at least one reinforcement element.

14. The method according to claim 9, further comprising pre-tensioning the at least one reinforcement element prior to applying the pre-tensioned reinforcement element on the first side of the electroactive polymer.

15. An apparatus comprising:
a rigid frame;
a first diaphragm;
a second diaphragm attached to the first diaphragm; and
an aperture defined at a center portion of the first and second diaphragms.

16. The apparatus according to claim 15, wherein the first and second diaphragms each comprise individually addressable electroactive portions.

17. The apparatus according to claim 5, wherein the at least one first reinforcement element comprises a ring applied about the aperture.

18. The apparatus according to claim 5, wherein the at least one reinforcement element comprises a first ring applied about the aperture on the first side of the electroactive polymer film and a second ring applied about the aperture on the second side of the electroactive polymer film.

19. The method according to claim 10, wherein pre-tensioning the electroactive polymer film prior to forming the aperture comprises applying a ring to at least one of the first side of the electroactive polymer film or the second side of the electroactive polymer film.

20. The apparatus of claim 15, wherein the first diaphragm and the second diaphragm are connected at the center portion such that the first diaphragm and the second diaphragm define a frustum.
